(19) United States
(12) Patent Application Publication
(10) Pub. No.: US 2016/0319097 A1
(43) Pub. Date: Nov. 3, 2016

(54) CHROMIUM-FREE NEAR-INFRARED REFLECTING DELAFOSSITE PIGMENTS

(71) Applicant: The Shepherd Color Company, Cincinnati, OH (US)

(72) Inventor: Matthew C. Comstock, Fairfield, OH (US)

(21) Appl. No.: 15/134,834

(22) Filed: Apr. 21, 2016

Related U.S. Application Data
(60) Provisional application No. 62/154,264, filed on Apr. 29, 2015.

(51) Int. Cl. C08K 3/00

(52) U.S. Cl. CPC C08K 3/0033

(57) ABSTRACT

The current technology is directed to an iron-substituted copper aluminum delafossite pigment, as well as a gallate version of the same. In particular, the materials may be defined as iron-substituted copper aluminum delafossite, CuFeₓAl₁₋ₓO₂ and the gallate, CuFeₓGa₁₋ₓO₂ where X=0.01 to 1.00, for example, CuFe_{0.15}Al_{0.85}O₂, and CuFe_{0.15}Ga_{0.85}O₂. The pigments are dark-brown to black, absorb most light in the visible spectrum, but have low absorbance and high reflectance in the near-infrared regions, specifically light from about 700 nm-2500 nm.

### BACKGROUND

When exposed to sunlight, surfaces with high solar reflectance are cooler than more absorbing surfaces. The use of pigments that scatter and reflect solar radiation in a variety of substrates like coatings, siding, and roofing material, may help mediate the Heat Island Effect, mitigate thermal-related mechanical failure, and reduce energy demand for cooling. White pigments that are reflective across the majority of solar irradiance wavelengths give the optimal level of solar reflectance. However, a large proportion of solar irradiance falls in the near-infrared region (NIR) above 780 nm. There are a number of complex inorganic pigments that are dark colored and absorb in the visible region from 400-780 nm, yet reflect sunlight in the near-infrared region from 780-2500 nm, for example, Chrome Iron Nickel Black Spinel, CI Pigment Black 30, and Iron Chromium Brown-Blacks, variously identified as CI Pigments Green 17, Brown 29, and Brown 35. While not as reflecting as white pigments, these near-infrared reflecting pigments allow greater color flexibility and can provide cooler surfaces than when using pigments that absorb more strongly across the wavelengths of solar irradiance.

Many near-infrared reflecting pigments, for example Iron Chromium Brown-Blacks, contain trivalent chromium. In some cases, pigments containing chromium have non-negligible levels of hexavalent chromium present. To avoid health and regulatory concerns, it is useful to have alternative pigments that provide similar color and reflectance properties, but do not contain chromium. The technology described herein is a chromium-free near-infrared reflecting black pigment.

### BRIEF SUMMARY

The current technology is directed to an iron-substituted copper aluminum delafossite pigment, as well as a gallate version of the same. The materials have the general formula ABO₂, where A is monovalent and B is trivalent, with a pattern of alternating layers of octahedrally coordinated B atoms separated by two-coordinate A atoms. In particular, the materials may be defined as near-infrared reflecting, iron-substituted solid solution copper delafossite pigments, that may have the formula Cu(FeₓAl₁₋ₓ)O₂ wherein X is 0.01-1.00; and near-infrared reflecting, iron-substituted solid solution copper delafossite pigments, that may have the formula Cu(FeₓAl₁₋ₓ)O₂ wherein X is 0.01-0.50. The corresponding near-infrared reflecting, iron-substituted solid solution copper gallate delafossite pigments may have the formula Cu(FeₓGa₁₋ₓ)O₂ wherein X is 0.01-1.00; and also have the formula Cu(FeₓGa₁₋ₓ)O₂ wherein X is 0.01-0.50.

Other near-infrared reflecting, iron-substituted solid solution copper delafossite pigments may have the formula CuFeₓM₁₋ₓO₂ wherein X is 0.01-1.00, and wherein M is a trivalent M³⁺ ion or a mixture of trivalent ions including B, Al, Sc, V, Cr, Mn, Ga, Y, Nb, In, Sb, La, Ce, Pr, Nd, Sm, Eu, Gd, Tb, Dy, Ho, Er, Tm, Yb, Lu, and mixtures thereof. In addition, M may be a trivalent M³⁺ ion or a mixture of trivalent ions including Al, Ga, In, and mixtures thereof.

Other near-infrared reflecting, iron-substituted solid solution copper delafossite pigments may have the formula A(FeₓM₁₋ₓ)O₂, wherein A is selected from Cu, Ag, Li, Na, K or a mixture of ions Cu, Ag, Li, Na, K, and M may be Al or Ga. X may range from 0.01-1.00. M may also be a trivalent M³⁺ ion or a mixture of trivalent ions including B, Al, Sc, V, Cr, Mn, Ga, Y, Nb, In, Sb, La, Ce, Pr, Nd, Sm, Eu, Gd, Tb, Dy, Ho, Er, Tm, Yb, Lu, and mixtures thereof. M may also be limited to trivalent ions including Al, Ga, In, and mixtures thereof. M may additionally comprise charge compensated ratios of monovalent, divalent, tetravalent, pentavalent, and hexavalent ions, wherein the monovalent ions may be Li, Na, K, or mixtures thereof, wherein the divalent ions may be Mn, Co, Ni, Mg, Ca, Zn, or mixtures thereof, the tetravalent ions may be Si, Ge, Ti, Zr, Sn, or mixtures thereof, the pentavalent ions may be Sb, Bi, V, Nb, or mixtures thereof, and the hexavalent ions may be Mo, W, or mixtures thereof, in ratios such that the average oxidation state is M³⁺ and charge neutrality is maintained.

### BRIEF DESCRIPTION OF DRAWINGS

FIG. 1: Overlay of reflectance spectra (R vs. nm) of pressed powders for Example 1, CuFe_{0.15}Al_{0.85}O₂, near-infrared reflecting Iron Chromium Oxide Brown-Black pigments Shepherd Color BK0010C909A and BK0010P923, and near-infrared reflecting Nickel Iron Oxide pigment, Shepherd Color BK0010C924.

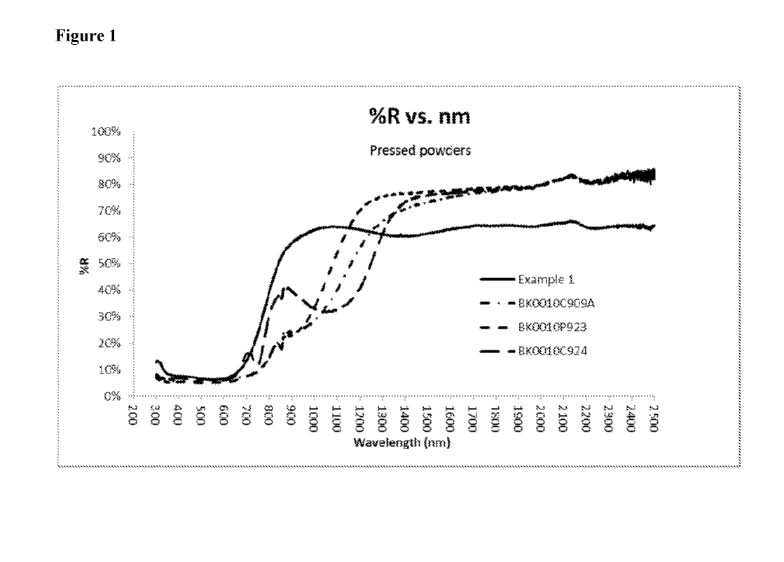

FIG. 2: Overlay of reflectance spectra (R vs. nm) of PVDF/acrylic masstone drawdowns for Example 1, CuFe_{0.15}Al_{0.85}O₂, near-infrared reflecting Iron Chromium Oxide Brown-Black pigments Shepherd Color BK0010C909A and BK0010P923, and near-infrared reflecting Nickel Iron Oxide pigment, Shepherd Color BK0010C924.

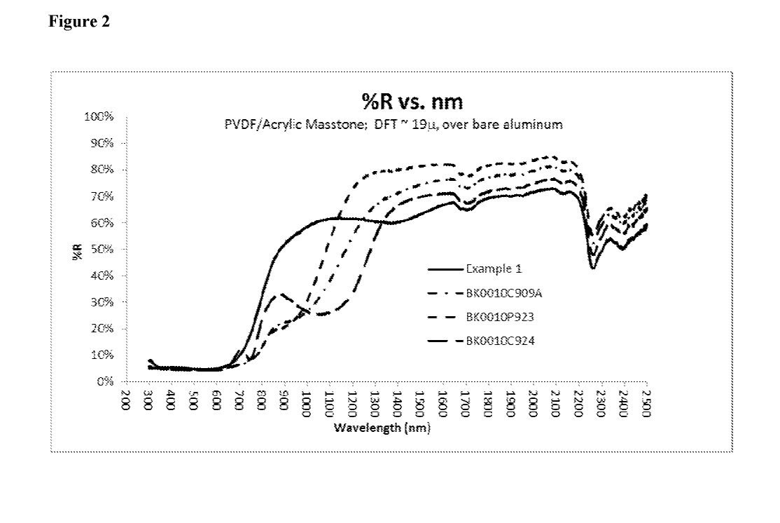

FIG. 3: Overlay of reflectance spectra (R vs. nm) of pressed powders for Examples 2, 6, 8, 9, and 10, CuFeₓAl₁₋ₓO₂, where X=0.01, 0.05, 0.15, 0.25, and 0.50, respectively. With increasing X, the band gap shifts to lower energy. This causes the region of absorption to expand to lower energy.

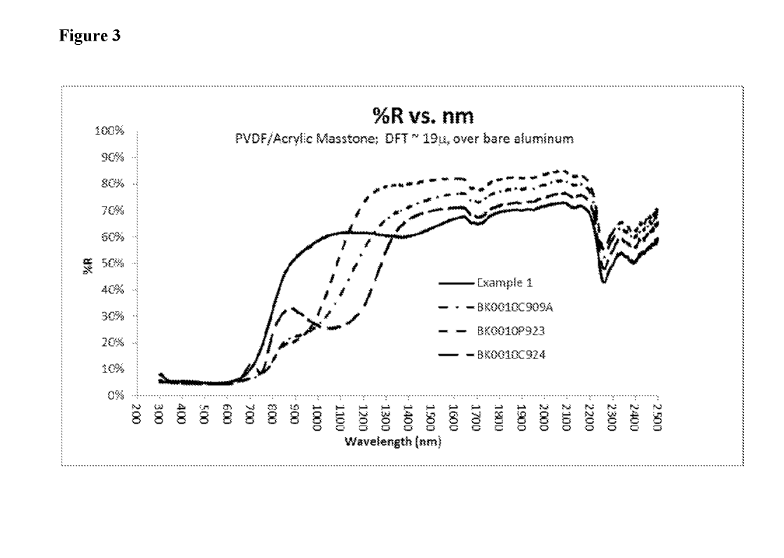

FIG. 4: Overlay of reflectance spectra (R vs. nm) of pressed powders Example 1, CuFeo_{0.15}Al_{0.85}O₂, and Example 11, CuFe_{0.15}Ga_{0.85}O₂. The band gap for the gallium-containing Example 11 is shifted to lower energy compared to the Al-containing Example 1. This causes the region of absorption for Example 11 to expand to lower energy compared to Example 1.

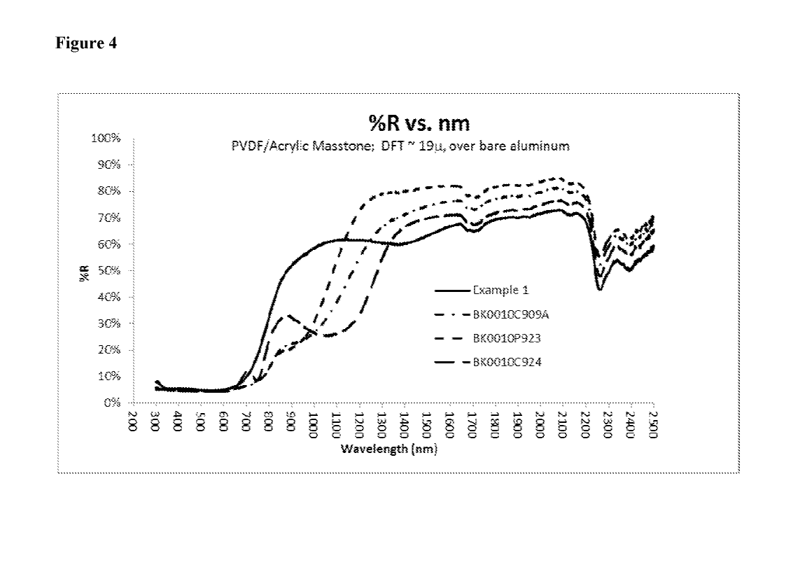

FIG. 5: Overlay of reflectance spectra (R vs. nm) of Acrylic Masstones for Example 1, CuFe_{0.15}Al_{0.85}O₂, Shepherd Color GR0410, and Shepherd Color BK0010P922.

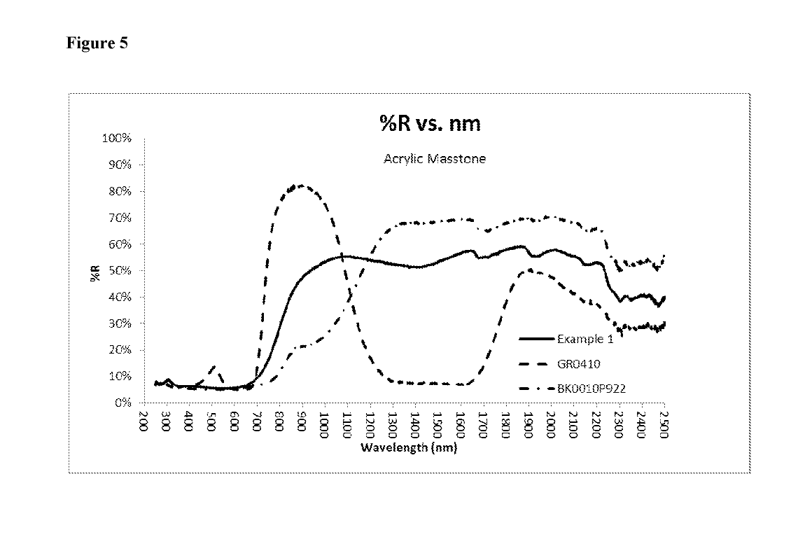

FIG. 6: Overlay of reflectance spectra (R vs. nm) of Acrylic Masstones for Shepherd Color GR0410 and Example 1, CuFe_{0.15}Al_{0.85}O₂, and Preparative Blends 1 and 3 of Example 1 with Shepherd Color GR0410.

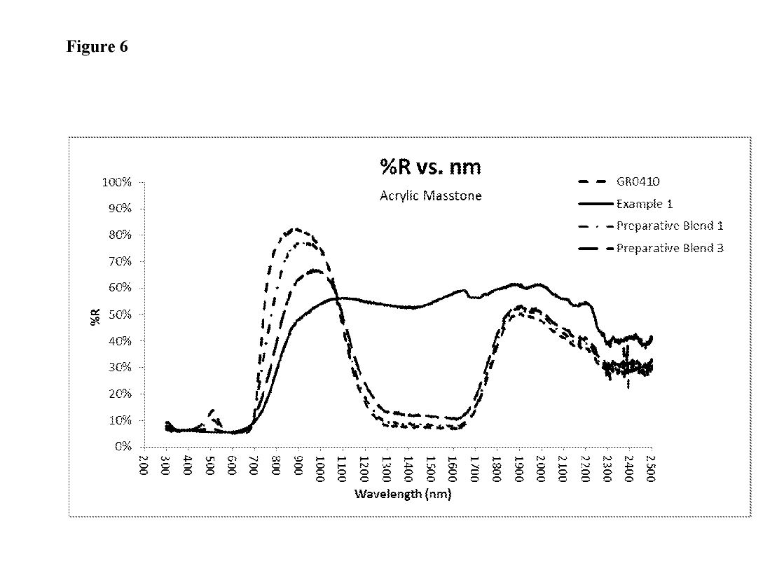

FIG. 7: Overlay of reflectance spectra (R vs. nm) of Acrylic Masstones for Shepherd Color GR0410 and Shepherd Color BK0010P922, and Preparative Blends 5 and 7 of Shepherd Color BK0010P922 with Shepherd Color GR0410.

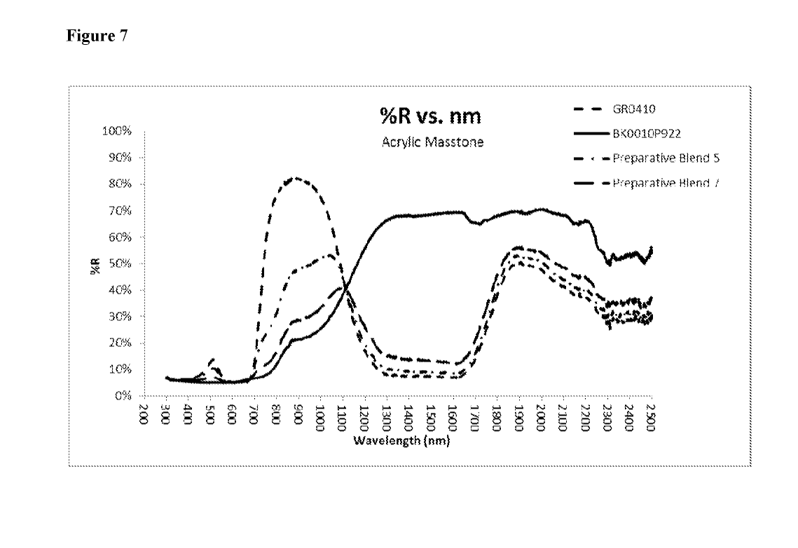

### DETAILED DESCRIPTION

Substitutional solid solutions of metal oxides form when metal ions of a solute metal oxide are incorporated in the lattice sites of a metal oxide solvent. Formation of a homogeneous solid solution phase relies on the balance of many factors, including oxidation state, ionic radius, electronegativities of metal ions, and crystal structures of solute and solvent metal oxides. In some cases a solid solution can form across an entire composition range of two end member oxides, such as the solid solution formed from reaction of Cr₂O₃ and Al₂O₃, (CrxAl₁₋ₓ)₂O₃, where X varies from 0 to 1. In other cases solid solutions will form a homogeneous phase only within a given range of X. CuAlO₂ and CuFeO₂ both crystallize with the ABO₂ delafossite structure, and the ionic radii for Al³⁺ and Fe³⁺ are similar in size. Under high temperature calcination of homogenized starting material mixtures of aluminum, iron and copper reagents, a solid solution is formed where both Fe and Al are present in the B site in the ABO₂ structure, Cu(FeₓAl₁₋ₓ)O₂ where X varies from 0 to 1. Similarly, gallium, iron, and copper reagents lead to solid solution products of the form Cu(FeₓGa₁₋ₓ)O₂. Solid solutions resulting from substitution at the A site with monovalent cations such as Ag⁺, Pt⁺, or Pd⁺ have also been observed in delafossite systems.

Substitution at sites in the solvent metal oxide with a metal ion of the same oxidation state is isovalent substitution. In solid solutions with aliovalent substitution, ions in the original metal oxide solvent structure are replaced with ions of a different charge. This can lead to cation or anion vacancies, or incorporation of charge balancing ions interstitially in normally unpopulated holes in the structure.

Alternatively, aliovalent substitution with more than one metal ion can maintain charge balance. For example, two Al³⁺ ions can be replaced with one Zn²⁺ ion and one Ti⁴⁺ ion, the average oxidation state across the two metals remains M³⁺, and charge neutrality is maintained.

Both isovalent and aliovalent substitution and formation of solid solutions can affect the electronic nature of the solvent metal oxide; the solid solution may exhibit properties different than those of the unsubstituted metal oxide. For example, the band structure and the optical absorption spectra of solid solutions may differ from those of either solute or solvent metal oxide. The delafossite solid solutions Cu(FeₓAl₁₋ₓ)O₂ and Cu(FeₓGa₁₋ₓ)O₂ where Fe³⁺ is substituted for the isovalent ions Al³⁺ or Ga³⁺ show additional absorption features through the visible region compared to the unsubstituted CuAlO₂ and CuGaO₂ materials. Additionally, alongside isovalent substitution of Al³⁺ or Ga³⁺ with Fe³⁺, concurrent aliovalent substitution with more than one metal ion, for example, two Al³⁺ ions replaced with one Zn²⁺ ion and one Ti⁴⁺ ion, may have additional affects on the electronic structure and resulting absorption features of the products compared to the isovalent substituted materials and provide the ability to shift the band gap and further tune the color and reflectance properties of the resulting pigments.

The current technology is directed to an iron-substituted copper aluminum delafossite pigment, as well as a gallate version of the same. In particular, the materials may be defined as iron-substituted solid solution copper aluminum delafossite CuFeₓAl₁₋ₓO₂ and the gallate, CuFeₓGa₁₋ₓO₂, X=0.01-1.00. The CuFeₓAl₁₋ₓO₂ and CuFeₓGa₁₋ₓO₂ pigments are dark-brown to black, exhibit band gaps near 1.5 eV, absorb most light in the visible spectrum, and have low absorbance and high reflectance in the near-infrared region, specifically light from about 700 nm-2500 nm. These properties are quantified in Total Solar Reflectance (TSR) values as determined via ASTM E903; CuFeₓAl₁₋ₓO₂ and CuFeₓGa₁₋ₓO₂ pigments have TSR values larger than those for pigments that are more absorbing across solar irradiance wavelengths. The reflectance reaches a local maximum for the CuFeₓAl₁₋ₓO₂ and CuFeₓGa₁₋ₓO₂ pigments near 1000 nm. Iron-Chromium Brown-Black pigments, with band gaps near 1.0 eV, also begin to show increased reflectance beginning near 700 nm; however, the reflectance curves rise more slowly as wavelength increases and only reach a local maximum reflectance around 1300 nm. Because solar irradiance is higher at wavelengths closer to the visible region, the CuFeₓAl₁₋ₓO₂ and CuFeₓGa₁₋ₓO₂ materials reflect more solar energy than a pigment that absorbs in this region. More specifically, the CuFeₓAl₁₋ₓO₂ and CuFeₓGa₁₋ₓO₂ materials absorb less and reflect more light than the traditional and industry-standard near-infrared reflecting Iron-Chromium Brown-Black pigments in a region beginning near 700 nm and extending to 1150 nm or higher.

It is not uncommon for metal oxides to deviate from perfect stoichiometry; that is, the ratio of elements in the formula ABO₂ may vary (the assumed 1:1:2 ratio for A, B, and O, respectively, may vary), although the material will still exhibit the same structure. These non-stoichiometric defect structures are within the scope of this technology and should be assumed throughout the application and claims.

Substitutions of the following forms are considered within the scope of this technology:

Mixed oxides of the form ABO₂ with a delafossite structure, where
1. A=Monovalent M⁺, and/or and mixtures of monovalent M⁺ ions
2. B=mixtures of Fe³⁺ with other trivalent M³⁺ ions
3. B=mixtures of Fe³⁺ with other trivalent M³⁺ ions and with other metals in ratios such that the average oxidation state is M³⁺ and charge neutrality is maintained

Below are examples of iron-substituted copper aluminum delafossite pigments. The list below is not comprehensive.
1. CuFe_{0.15}Al_{0.85}O₂
2. CuFe_{0.15}Ga_{0.85}O₂
3. CuFeₓAl₁₋ₓO₂
   a. X=0.01-1.00
4. CuFeₓGa₁₋ₓO₂
   a. X=0.01-1.00
5. CuFeₓM₁₋ₓO₂
   a. X=0.01-1.00
   b. M=trivalent M³⁺ ion or a mixture of trivalent ions including B, Al, Sc, V, Cr, Mn, Ga, Y, Nb, In, Sb, La, Ce, Pr, Nd, Sm, Eu, Gd, Tb, Dy, Ho, Er, Tm, Yb, Lu, and mixtures thereof.
6. CuFeₓM₁₋ₓO₂
   a. X=0.01-1.00
   b. M=a mixture of trivalent M³⁺ ions and other metals in ratios such that the average oxidation state is M³⁺ and charge neutrality is maintained.
7. All the formulas above, replacing Cu in part or in total with other monovalent metals including Ag, Li, Na, K

### EXAMPLES

### Example 1

A mixture of 167.1 grams copper (I) oxide (Cu₂O), 154.9 grams aluminum hydroxide (Al(OH)₃) and 28.0 grams iron (III) oxide (Fe₂O₃) with molar ratios of Cu:Al:Fe=1.00:0.85:0.15 was homogenized and calcined for six hours at 1050° C. under flowing argon in a tube furnace. The resulting 291.0 grams were combined and a 250 g portion was jet-milled to give Example 1 with a D50 particle size of 1.02 microns (50 of the particles below 1.0 microns) as measured on a Microtrac S3500 laser scattering instrument to give Example 1 with a formula of CuFe_{0.15}Al_{0.85}O₂

TABLE 1
Particle Size Distributions for Example
1 and Shepherd Color BK0010C909A,

| | BK0010P923, and BK0010C924 | | | | | |
|---|---|---|---|---|---|---|
| | D10 | D20 | D50 | D80 | D90 | Mean |
| | μm) | μm) | μm) | μm) | μm) | μm) |
| Example 1 | 0.49 | 0.63 | 1.02 | 1.62 | 2.09 | 1.21 |
| BK0010C909A | 0.89 | 1.15 | 1.67 | 2.42 | 3.05 | 1.89 |
| BK0010P923 | 0.98 | 1.19 | 1.63 | 2.27 | 2.77 | 1.81 |
| BK0010C924 | 2.01 | 2.34 | 3.06 | 4.05 | 4.80 | 3.29 |

Microtrac S3500 laser scattering instrument

### Examples 2 10

A series of samples were prepared using the molar ratios and mass of reagents as listed in the table below. Mixtures of reagents were homogenized and calcined for six hours at 1050° C. under flowing argon in a tube furnace to give Examples 2-10 with formulas CuFeₓAl₁₋ₓO₂; X=0.01-0.50 as indicated in Table 2 below.

TABLE 2
Molar ratios and grams of reagents for Examples 2-10

| | Molar ratios | | | Grams of reagents | | |
|---|---|---|---|---|---|---|
| | Cu | Al | Fe | Cu₂O | Al(OH)₃ | Fe₂O₃ |
| Example 2 | 1.00 | 0.99 | 0.01 | 1.91 | 2.07 | 0.02 |
| Example 3 | 1.00 | 0.98 | 0.02 | 1.91 | 2.04 | 0.04 |
| Example 4 | 1.00 | 0.97 | 0.03 | 1.91 | 2.02 | 0.06 |
| Example 5 | 1.00 | 0.96 | 0.04 | 1.91 | 2.00 | 0.09 |
| Example 6 | 1.00 | 0.95 | 0.05 | 1.91 | 1.98 | 0.11 |
| Example 7 | 1.00 | 0.94 | 0.06 | 1.91 | 1.96 | 0.13 |
| Example 8 | 1.00 | 0.85 | 0.15 | 1.91 | 1.77 | 0.32 |
| Example 9 | 1.00 | 0.75 | 0.25 | 1.91 | 1.56 | 0.53 |
| Example 10 | 1.00 | 0.50 | 0.50 | 1.90 | 1.04 | 1.06 |

### Example 11

A mixture of 1.32 grams copper (I) oxide (Cu₂O), 1.47 grams gallium oxide Ga₂O₃) and 0.22 grams iron (III) oxide (Fe₂O₃) with molar ratios of Cu:Ga:Fe=1.00:0.85:0.15 was homogenized and calcined for six hours at 1200° C. under flowing argon in a tube furnace to give Example 11 with a formula of CuFe_{0.15}Ga_{0.85}O₂.

### X-Ray Powder Diffraction Data:

X-ray powder diffraction measurements were made at room temperature using a Rigaku X ray diffractometer with Cu Kα radiation at 40 kV and 40 mA from 2θ=10° to 75° at 1°/min. Powder diffraction measurements were made for Examples 1-11. The dominant structure exhibited for Examples 1-11 was the expected Cu(Fe,M)O₂ phase (M=Al, Ga) identified by comparing peaks with the CuAlO₂ or CuGaO₂ patterns. Trace phases included Cu metal, and Al₂O₃ or Ga₂O₃. Table 3 indicates the observed phase composition for Examples 1-11.

TABLE 3
X-ray Powder Diffraction phase composition for Examples 1-11

| | XRD Observed Phases ( ) | | | | |
|---|---|---|---|---|---|
| | CuAlO₂ | Cu | Al₂O₃ | CuGaO₂ | Ga₂O₃ |
| Example 1 | 94.0 | 2.0 | 4.0 | | |
| Example 2 | 84.0 | 9.0 | 7.0 | | |
| Example 3 | 87.0 | 7.0 | 5.0 | | |
| Example 4 | 87.0 | 7.0 | 6.0 | | |
| Example 5 | 88.0 | 8.0 | 4.0 | | |
| Example 6 | 89.0 | 7.0 | 4.0 | | |
| Example 7 | 88.0 | 7.0 | 5.0 | | |
| Example 8 | 93.0 | 5.0 | 3.0 | | |
| Example 9 | 95.0 | 4.0 | 1.0 | | |
| Example 10 | 96.0 | 4.0 | | | |
| Example 11 | | 3.0 | | 83.0 | 14.0 |

### Color Values, TSR, and Band Gaps

TABLE 4
D65 illuminant, 10° observer, CIE color values, total
solar reflectance (TSR) and band gaps determined via the
Tauc method for pressed powders for Examples 1-11 and Shepherd
Color pigments BK0010C909A, BK0010P923, and BK0010C924.

| | | | | | Band |
|---|---|---|---|---|---|
| | L* | a* | b* | TSR | gap (eV) |
| Example 1 | 30.7 | 3.2 | −2.6 | 33.6 | 1.45 |
| Example 2 | 50.3 | 12.4 | 0.9 | 50.4 | 1.62 |
| Example 3 | 42.6 | 12.6 | 0.2 | 48.8 | 1.62 |
| Example 4 | 38.4 | 10.5 | −1.3 | 45.7 | 1.59 |
| Example 5 | 33.4 | 10.4 | −1.0 | 44.1 | 1.59 |
| Example 6 | 32.8 | 8.5 | −2.0 | 42.4 | 1.57 |
| Example 7 | 29.5 | 8.7 | −1.7 | 42.4 | 1.58 |
| Example 8 | 23.9 | 4.1 | −1.6 | 36.5 | 1.50 |
| Example 9 | 23.3 | 1.8 | −1.8 | 29.2 | 1.44 |
| Example 10 | 21.9 | 0.8 | −1.1 | 16.0 | 1.30 |
| Example 11 | 24.6 | 1.1 | −1.8 | 25.1 | 1.42 |
| BK0010C909A | 28.8 | 1.2 | 1.2 | 25.4 | 0.91 |
| BK0010P923 | 27.2 | 1.1 | −0.2 | 27.4 | 1.00 |
| BK0010C924 | 29.9 | 1.7 | −1.0 | 28.1 | 0.88 |

PerkinElmer Lambda 900 UV/Vis/NIR, ASTM E903/E891
D65 illuminant 10° Standard Observer

TABLE 5
D65 illuminant, 10° observer, CIE color values for
PVDF/Acrylic Masstone and 4:1 tint drawdowns, and
Masstone total solar reflectance (TSR) values for
Example 1 and Shepherd Color pigments
BK0010C909A, BK0010P923, and BK0010C924.

| | Masstone | | | | 4:1 Tint | | |
|---|---|---|---|---|---|---|---|
| | L* | a* | b* | TSR | L* | a* | b* |
| Example 1 | 26.2 | 2.9 | −1.0 | 30.6 | 65.3 | 0.1 | −5.0 |
| BK0010C909A | 24.6 | 1.8 | 0.8 | 24.4 | 66.8 | −0.5 | −4.8 |
| BK0010P923 | 24.9 | 1.1 | 0.0 | 28.1 | 68.7 | −1.2 | −5.4 |
| BK0010C924 | 24.9 | 2.0 | −0.1 | 22.7 | 73.7 | 0.1 | −3.1 |

Macbeth Coloreye instrument/D65 illuminant 10° Standard Observer; ASTM E903/E891, Device and Services Solar Spectrum Reflectometer Model SSR-ER instrument

### Illustrative Example

### Preparative Blends of Example 1 with Other Pigments

In industrial application it is common to use a mixture of pigments to obtain a desired color shade. Addition of black pigments to forest-green shade pigments is one route to a dark-green or olive-shade camouflage color. Both Shepherd Color pigment GR0410 (CI pigment Green 26 Cobalt Chromite Spinel) and Example 1 have high reflectance in the region between 700 and 1100 nm. In contrast, the standard near-infrared pigment BK0010P922 (CI Pigment Green 17 Chromium Green-Black Hematite) reflects less, and absorbs more strongly, in this region. As a result, the Preparative Blends of GR0410 using Example 1 have similar color but higher reflectance in the 700-1100 nm region, quantified in the table at 760 nm, and have higher TSR than blends of GR0410 with BK0010P922.

TABLE 9
D65 illuminant, 10° observer, CIE color values for acrylic masstone drawdowns,
masstone reflectance values at 760 nm, and masstone total solar reflectance (TSR) values,
for Example 1, Shepherd Color pigments GR0410, BK0010P922, and Preparative Blends.
Grams of individual pigments used in Preparative Blends are shown in the table.

| Sample | GR0410 | Example 1 | BK0010P922 | Black | L* | a* | b* | R (760) | TSR |
|---|---|---|---|---|---|---|---|---|---|
| GR0410 | 2.500 | | | | 34.6 | −18.0 | 0.0 | 0.63 | 31.1 |
| Example 1 | | 2.500 | | | 28.5 | 1.9 | −1.6 | 0.19 | 28.4 |
| BK0010P922 | | | 2.500 | | 27.2 | 1.1 | −0.3 | 0.08 | 22.9 |
| Preparative blend 1 | 2.375 | 0.125 | | 5 | 32.4 | −10.6 | −1.3 | 0.43 | 28.4 |
| Preparative blend 2 | 2.250 | 0.250 | | 10 | 30.9 | −6.1 | −1.7 | 0.33 | 26.3 |
| Preparative blend 3 | 2.000 | 0.500 | | 20 | 29.6 | −2.0 | −1.8 | 0.26 | 24.7 |
| Preparative blend 4 | 1.750 | 0.750 | | 30 | 29.2 | −0.4 | −1.8 | 0.23 | 23.9 |
| Preparative blend 5 | 2.375 | | 0.125 | 5 | 32.4 | −11.7 | −0.9 | 0.24 | 21.3 |
| Preparative blend 6 | 2.250 | | 0.250 | 10 | 30.7 | −7.8 | −1.1 | 0.17 | 18.3 |
| Preparative blend 7 | 2.000 | | 0.500 | 20 | 29.3 | −4.4 | −1.1 | 0.12 | 16.7 |
| Preparative blend 8 | 1.750 | | 0.750 | 30 | 28.3 | −1.9 | −0.9 | 0.10 | 16.5 |

PerkinElmer Lambda 900 UV/Vis/NIR, ASTM E903/E891
D65 illuminant 10° Standard Observer

What is claimed:

1. A near-infrared reflecting, iron-substituted solid solution copper delafossite pigment, having a formula Cu(FeₓAl₁₋ₓ)O₂ wherein X is 0.01-1.00.

2. A near-infrared reflecting, iron-substituted solid solution copper delafossite pigment, having a formula Cu(FeₓGa₁₋ₓ)O₂ wherein X is 0.01-1.00.

3. A near-infrared reflecting, iron-substituted solid solution copper delafossite pigment, having a formula Cu(FeₓAl₁₋ₓ)O₂ wherein X is 0.01-0.50.

4. A near-infrared reflecting, iron-substituted solid solution copper delafossite pigment, having a formula Cu(FeₓGa₁₋ₓ)O₂ wherein X is 0.01-0.50.

5. A near-infrared reflecting, iron-substituted solid solution copper delafossite pigment, having a formula CuFe_{0.15}Al_{0.85}O₂.

6. A near-infrared reflecting, iron-substituted solid solution copper delafossite pigment, having a formula CuFe_{0.15}Ga_{0.85}O₂.

7. A near-infrared reflecting, iron-substituted solid solution copper delafossite pigment, having a formula CuFeₓM₁₋ₓO₂ wherein X is 0.01-1.00.

8. The pigment of claim 7 wherein M is a trivalent M3+ ion or a mixture of trivalent ions including B, Al, Sc, V, Cr, Mn, Ga, Y, Nb, In, Sb, La, Ce, Pr, Nd, Sm, Eu, Gd, Tb, Dy, Ho, Er, Tm, Yb, Lu, and mixtures thereof.

9. The pigment of claim 7 wherein M is a trivalent M3+ ion or a mixture of trivalent ions including Al, Ga, In, and mixtures thereof.

10. A near-infrared reflecting, iron-substituted solid solution copper delafossite pigment, having a formula A(FeₓM₁₋ₓ)O₂.

11. The pigment of claim 10 wherein A is selected from Cu, Ag, Li, Na, K or a mixture of ions Cu, Ag, Li, Na, K.

12. The pigment of claim 10 wherein A is Cu.

13. The pigment of claim 10 wherein M is Al.

14. The pigment of claim 10 wherein M is Ga.

15. The pigment of claim 10, wherein X is 0.01-1.00.

16. The pigment of claim 10 wherein M is a trivalent M3+ ion or a mixture of trivalent ions including B, Al, Sc, V, Cr, Mn, Ga, Y, Nb, In, Sb, La, Ce, Pr, Nd, Sm, Eu, Gd, Tb, Dy, Ho, Er, Tm, Yb, Lu, and mixtures thereof.

17. The pigment of claim 10 wherein M is a trivalent M3+ ion or a mixture of trivalent ions including Al, Ga, In, and mixtures thereof.

18. The pigment of claim 10 wherein M is a trivalent M3+ ion or a mixture of trivalent ions including B, Al, Sc, V, Cr, Mn, Ga, Y, Nb, In, Sb, La, Ce, Pr, Nd, Sm, Eu, Gd, Tb, Dy, Ho, Er, Tm, Yb, Lu, and mixtures thereof, and wherein M additionally comprises charge compensated ratios of monovalent, divalent, tetravalent, pentavalent, and hexavalent ions, wherein the monovalent ions are Li, Na, K, or mixtures thereof, wherein the divalent ions are Mn, Co, Ni, Mg, Ca, Zn, or mixtures thereof, the tetravalent ions are Si, Ge, Ti, Zr, Sn, or mixtures thereof, the pentavalent ions are Sb, Bi, V, Nb, or mixtures thereof, and the hexavalent ions are Mo, W, or mixtures thereof, in ratios such that the average oxidation state is M3+ and charge neutrality is maintained.
